(19) United States
(12) Patent Application Publication
(10) Pub. No.: US 2003/0068174 A1
(43) Pub. Date: Apr. 10, 2003

(54) Toner cartridge and electrophotographic apparatus adopting the same

(75) Inventors: Toshifumi Hashimoto, Yokohama (JP); Takashi Ando, Yokohamo (JP)

Correspondence Address: STAAS & HALSEY LLP, 700 11TH STREET, NW, SUITE 500, WASHINGTON, DC, 20001, US

(73) Assignee: Samsung Electronics co., Ltd.

(21) Appl. No.: 10/244,590

(22) Filed: Sep. 17, 2002

(30) Foreign Application Priority Data
Sep. 17, 2001 (JP) 2001-282431

(51) Int. Cl. G03G 15/08

(52) U.S. Cl. 399/120

(57) ABSTRACT

A toner cartridge which is detachably loaded in a predetermined loading portion and has a new toner containing space where new toner is contained and a waste toner containing space where waste toner is contained, the toner cartridge including a supply hole for supplying new toner and a receiving hole for receiving waste toner, which are installed at a predetermined position of a main body of the toner cartridge, and an open and shut mechanism for opening and shutting the supply hole and the receiving hole by a single shutter. An electrophotographic apparatus for forming an image on a recording medium by adhering toner to a photoreceptive body where an electrostatic latent image is formed and transferring the toner to the recording medium from the photoreceptive body, in which the electrophotographic apparatus includes a loading portion where the toner cartridge is detachably installed the toner cartridge. The toner cartridge comprises a new toner containing space where new toner is contained and a waste toner containing space where waste toner is contained, a supply hole for supplying new toner and a receiving hole for receiving waste toner, which are installed at a predetermined position of a main body of the toner cartridge, and an open and shut mechanism for opening and shutting the supply hole and the receiving hole by a single shutter.

### CROSS-REFERENCE TO RELATED APPLICATIONS

This application claims the benefit of Japanese Application No. 2001-282431, filed Sep. 17, 2001, in the Japanese Patent Office, the disclosure of which is incorporated herein by reference.

### BACKGROUND OF THE INVENTION

1. Field of the Invention

The present invention relates to a toner cartridge and an electrophotographic apparatus adopting the same, and more particularly, to a toner cartridge in which a structure to supply new toner and a structure to contain waste toner are improved, and an electrophotographic apparatus adopting the same

2. Description of the Related Art

In general, an electrophotographic apparatus forms an image on a recording medium by attaching toner powder to a surface of an object such as photoreceptor where an electrostatic latent image is formed and transferring the toner from the surface of the object to the recording medium. Also, the unnecessary toner attached to the surface of the object is collected as the waste toner.

Typically, as a method of supplying toner to the electrophotographic apparatus, there is a method of directly supplying toner from the outside and a method of replacing a toner cartridge by removing an old toner cartridge from a main body and installing a new one.

FIGS. 1A through 1C show a conventional toner cartridge used in a cartridge replacement type electrophotographic apparatus. Referring to FIG. 1A, a toner cartridge 70 has a new toner containing portion 71 as a space for containing new toner and a waste toner containing portion 72 as a space for containing waste toner. A supply hole 73 through which new toner is supplied to the outside is installed at the new toner containing portion 71. A receiving hole 74 through which waste toner is received from the outside is installed at the waste toner containing portion 72.

Also, open/shut mechanisms 75 and 76 are installed at the supply hole 73 and the receiving hole 74, respectively, in order to prevent contamination by the toner during the replacement of a cartridge. FIG. 1B shows the open/shut mechanism 75 installed at the supply hole 73. FIG. 1C shows the open/shut mechanism 76 installed at the receiving hole 74.

For example, the open/shut mechanism 75 of FIG. 1B opens and shuts the supply hole 73 by moving a shutter member 77 in a circumferential direction. The open/shut mechanism 76 of FIG. 1C opens and shuts the receiving hole 74 by moving a shutter member 79 connected to a metal spring member 78 to slide linearly.

The conventional apparatus having the above structure has a complicated structure so that a manufacturing cost is raised and replacement of a toner cartridge becomes inconvenient and difficult. Accordingly, a toner cartridge and an electrographic apparatus which are cheap and provide convenience in replacement are needed.

### SUMMARY OF THE INVENTION

To solve the above-described problems, it is an object of the present invention to provide a toner cartridge which is cheap and easy to be replaced, and an electrophotographic apparatus adopting the same.

To achieve the above object, there is provided a toner cartridge which is detachably loaded in a predetermined loading portion and has a new toner containing space where new toner is contained and a waste toner containing space where waste toner is contained, the toner cartridge comprising a supply hole for supplying new toner and a receiving hole for receiving waste toner, which are installed at a predetermined position of a main body of the toner cartridge; and an open and shut mechanism for opening and shutting the supply hole and the receiving hole by a single shutter.

It is preferred in the present invention that the open and shut mechanism opens and shuts the supply hole and the receiving hole by operating the shutter, in engagement with installation and detaching operations with respect to the loading portion, and that the open and shut mechanism comprises a driven portion installed at the shutter, and a guide groove formed in the loading portion so that the driven portion moves when the toner cartridge is installed at or detached from the loading portion, for guiding the movement of the shutter through the driven portion.

It is preferred in the present invention that every elements including the open and shut mechanism is formed of resin.

It is preferred in the present invention that the toner cartridge further comprises at least one of a first transfer unit for transferring the new toner from the new toner containing space to the supply hole and a second transfer unit for transferring the waste toner from the receiving hole to the waste toner containing space.

To achieve the above object, there is provided an electrophotographic apparatus for forming an image on a recording medium by adhering toner to a photoreceptive body where an electrostatic latent image is formed and transferring the toner to the recording medium from the photoreceptive body, the electrophotographic apparatus comprising a loading portion where the toner cartridge is detachably installed the toner cartridge, wherein the toner cartridge comprises a new toner containing space where new toner is contained and a waste toner containing space where waste toner is contained, a supply hole for supplying new toner and a receiving hole for receiving waste toner, which are installed at a predetermined position of a main body of the toner cartridge, and an open and shut mechanism for opening and shutting the supply hole and the receiving hole by a single shutter.

### BRIEF DESCRIPTION OF THE DRAWINGS

The above object and advantages of the present invention will become more apparent by describing in detail preferred embodiments thereof with reference to the attached drawings in which:

FIG. 1A is a perspective view illustrating a conventional toner cartridge used in an electrophotographic apparatus;

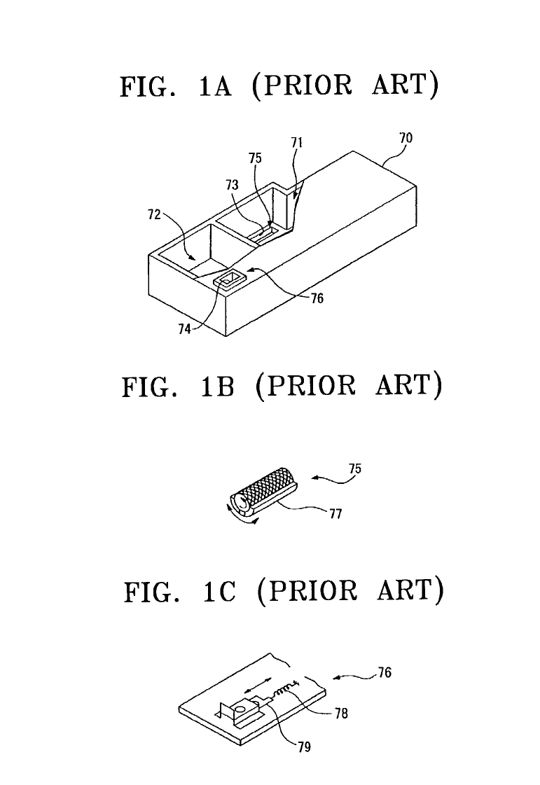

FIGS. 1B and 1C are perspective views illustrating the open/shut mechanism of FIG. 1A;

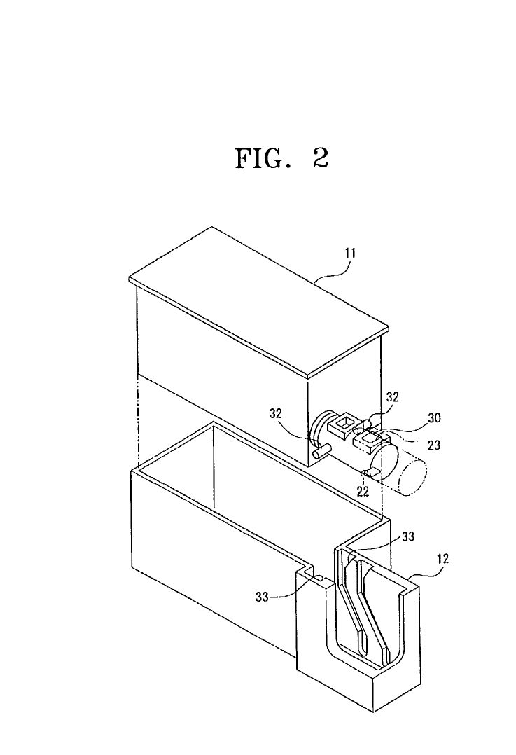

FIG. 2 is a perspective view illustrating a toner cartridge according to a preferred embodiment of the present invention;

FIG. 3 is a sectional view illustrating the toner cartridge of FIG. 2;

FIGS. 4A through 4d are views for explaining the structure and operation of the open/shut portion according to a preferred embodiment of the present invention;

FIGS. 5A and 5B are sectional views illustrating the toner cartridge of FIG. 2; and

FIG. 6 is a sectional view illustrating an electrophotographic apparatus according to a preferred embodiment of the present invention.

### DETAILED DESCRIPTION OF THE INVENTION

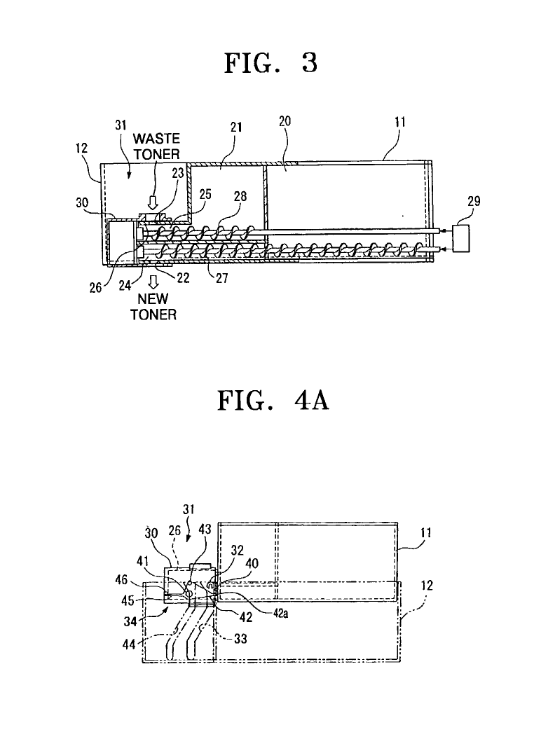

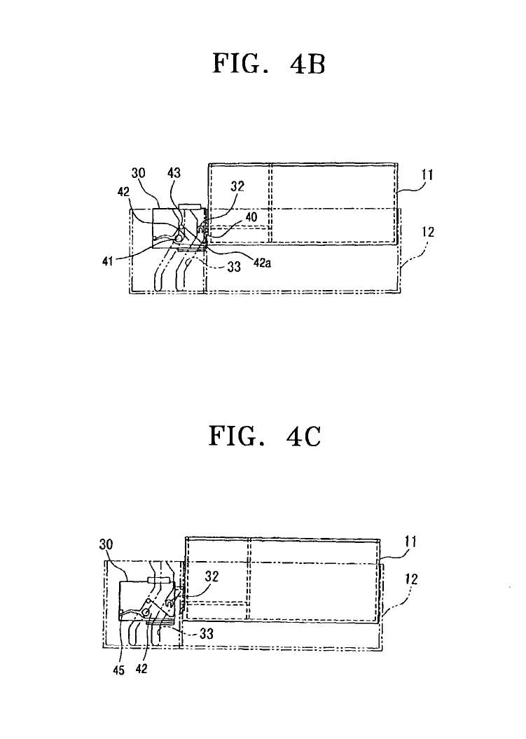

Referring to FIGS. 2 and 3, a toner cartridge 11 according to a preferred embodiment of the present invention is detachably loaded in a loading portion 12 installed at an electrophotographic apparatus. The loading portion 12 has a box shape with one open side through which the toner cartridge 11 is detachably loaded.

The toner cartridge 11 includes a new toner containing portion 20 that is a space for containing new toner powder and a waste toner containing portion 21 that is a space for containing unnecessary toner collected from the electrophotographic apparatus. Also, the toner cartridge 11 has a supply hole 22 through which new toner is supplied to the outside, that is, the loading portion 12 of the electrophotographic apparatus, and a receiving hole 23 through which waste toner is received. The supply hole 22 is connected to the new toner containing portion 20 via a supply path 24. The receiving hole 23 is connected to the waste toner containing portion 21 via a receiving path 25.

To make structures for the loading portion of the electrophotographic apparatus and the toner cartridge compact, the supply hole 22 and the receiving hole 23 should be installed to be adjacent to each other. For this, the toner cartridge 11 includes an input/output portion 26 that is cylindrical and protruding. The supply hole 22 and the receiving hole 23 are installed at predetermined positions on a surface of the cylindrical input/output portion 26. The inner space of the input/output portion 26 are divided into two paths, that is, the supply path 24 and the receiving path 25. The supply path 24 connects the supply hole 22 and the new toner containing portion 20. The supply path 24 connects the receiving hole 23 and the waste toner containing portion 21. Here, the shape of the input/output portion 26 is not limited to a cylinder and any shapes can be adopted.

Also, the toner cartridge 11 includes a transfer unit for transferring new toner and waste toner. The transfer toner is connected to the driving portion 29 installed at the loading portion 12 and includes first and second screws 27 and 28 carrying the toner by the rotation.

The first screw 27 is installed to be capable of rotating at the supply path 24 and the new toner containing portion 20 and transfers the new toner toward the supply hole 22 from the new toner containing portion 20. The second screw 28 is installed to be capable of rotating through the receiving path 25 and the waste toner containing portion 21 and transfers waste toner toward the waste toner containing portion 21 from the receiving hole 23.

As described above, the new toner and the waste toner are easily transferred by the transfer unit. The input/output portion 26 is provided so that the supply hole 22 and the receiving hole 23 are disposed at one place. Thus, the toner cartridge 11 can be made compact.

Also, the toner cartridge 11 has an open/shut portion 31 for opening/shutting the supply hole 22 and the receiving hole 23. The open/shut portion 31 opens the supply hole 22 and the receiving hole 23 when the toner cartridge 11 is installed at the loading portion 12 and shuts the supply hole 22 and the receiving hole 23 when the toner cartridge 11 is detached.

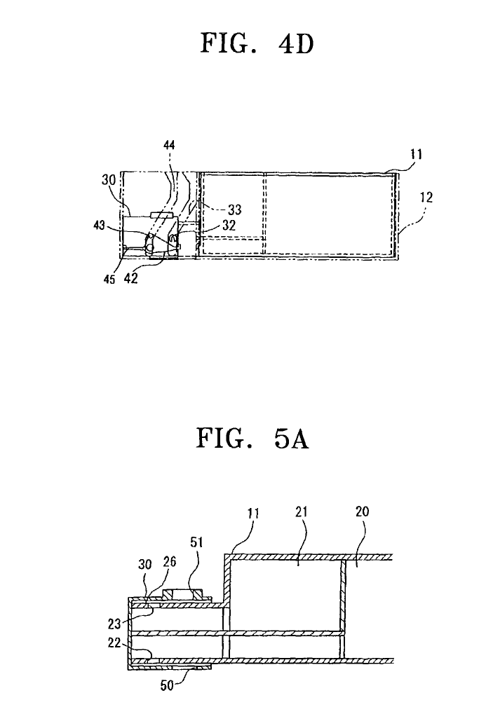

Referring to FIGS. 4A through 4D, the open/shut portion 31 includes a shutter 30, a driven portion 32 installed at the outer surface of the shutter 30 as a coupling portion, a guide groove 33 formed in the inner surface of the loading portion 12, and a locking mechanism 34 for locking the movement of the shutter 30. Also, the driven portion 32 and the guide groove 33 are installed at the opposite surface.

The shutter 30 has a shape corresponding to the input/output portion 26, for example, a cylindrical shape, in which one side is open while the other sides are closed. The shutter 30 is inserted around the input/output portion 26 through the open side to be capable of sliding in the axial direction of the input/output portion 26. Openings 50 and 51 corresponding to the supply hole 22 and the receiving hole 23 are formed in the shutter 30.

In the open/shut portion 31 having the above structure, the driven portion 32 moves along the guide groove 33 when the toner cartridge 11 is installed at or detached from the loading portion 12. Here, the guide groove 33 guides the shutter 30 moving in the axial direction of the input/output portion 26 by the driven portion 32 when the toner cartridge 11 is installed at or detached from the loading portion 12.

The locking mechanism 34 includes a hooking step 40 installed at a main body of the toner cartridge 11, a locking arm 42 installed at the shutter 30 to be capable of rotating around a pivot shaft 41, a guide groove 44 for a locking arm installed in the loading portion 12, and a driven portion 43 for a locking arm, protruding from the locking arm 42, for moving along the guide groove 44 for a locking arm.

The locking arm 42 is formed of resin such as polyacetal and part (an elastic portion 45) of which is formed as a thin plate to function as an elastic body. One end of the elastic portion 45 contacts a protrusion 46 installed at the shutter 30 and is bent according to a change of an installation angle of the locking arm 42 with respect to the pivot shaft 41. As the driven portion 43 for a locking arm moves along the guide groove 44 for a locking arm, the installation angle of the locking arm 42 changes. Also, as a hook 42a of the locking arm 42 is caught by the hooking step 40, the shutter 30 stops moving in the axial direction. When the hook 42a is released from the hooking step 40, the shutter 30 can move in the axial direction.

In the present preferred embodiment, the locking mechanism 34 locks the shutter 30 not to move when the toner cartridge 11 is detached from the loading portion 12, and releases the locking at the initial stage when the toner cartridge 11 is loaded in the loading portion 12.

Next, the operation of the open/shut portion 31 when the toner cartridge 11 is loaded in the loading portion 12 will now be described with reference to FIG. 4A through FIG. 4D.

FIG. 4A shows a step before the toner cartridge 11 is loaded in the loading portion 12. Here, the shutter 30 is disposed at a position most close to the main body of the toner cartridge 11. Since the hook 42a is caught by the hooking step 40, the shutter 30 cannot be moved in the axial direction of the shutter 30.

FIG. 4B shows an initial step in which the toner cartridge 11 is loaded in the loading portion 12. As the driven portion 43 for a locking arm is guided along the guide groove 44 for a locking arm, the locking arm 42 rotates around the pivot shaft 41 so that the installation angle changes. Thus, the hook 42a is separated from the hook step 40 so that the shutter 30 is unlocked.

FIG. 4C shows the step in which the toner cartridge 11 is being loaded in the loading portion 12. The driven portion 32 installed at the shutter 30 is moved in the axial direction of the shutter 30 along the guide groove 33 installed in the loading portion 12. Accordingly, the shutter 30 that is unlocked moves in a direction away from the main body of the toner cartridge 11. Here, the elastic portion 45 of the locking arm 42 is bent.

FIG. 4D shows the step in which the toner cartridge 11 is completely loaded in the loading portion 12. The shutter 30 is arranged at a position most away from the main body of the toner cartridge 11. Here, the position of the driven portion 43 for a locking arm moved by being guided by the guide groove 44 for a locking arm is changed. The elastic portion 45 of the locking arm 42 is returned from the bent state to the original state.

As described above, the open/shut portion 31 is operated by being engaged with an installation operation when the toner cartridge 11 is installed at the loading portion 12. That is, the shutter 30 is moved in a direction to be separated from the main body of the toner cartridge 11. In contrast, when the toner cartridge 11 is detached from the loading portion 12, the open/shut portion 31 operates in the opposite order and the shutter 30 is locked by the locking mechanism 34 before being detached.

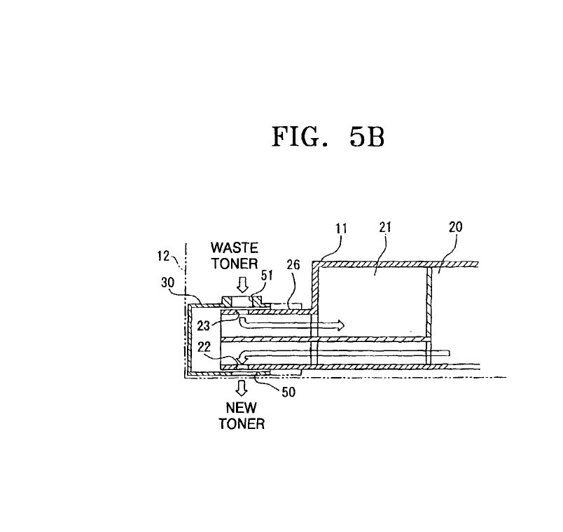

FIG. 5A shows a state in which the toner cartridge 11 is detached from the loading portion 12. FIG. 5B shows a state in which the toner cartridge 11 is loaded in the loading portion 12.

Referring to FIG. 5A, when the toner cartridge 11 is detached from the loading portion 12, the shutter 30 is disposed at a position most close to the main body of the toner cartridge 11. In this case, the positions of the openings 50 and 51 of the shutter 30, and the supply hole 22 and the receiving hole 23 of the toner cartridge 11, are deviated from each other in the axial direction. Thus, the supply hole 22 and the receiving hole 23 are in a shut state.

Referring to FIG. 5B, when the toner cartridge 11 is loaded in the loading portion 12, the shutter 30 is disposed at a position most away from the main body of the toner cartridge 11. In this case, the positions of the openings 50 and 51 of the shutter 30, and the supply hole 22 and the receiving hole 23 of the toner cartridge 11, match each other in the axial direction. Thus, the supply hole 22 and the receiving hole 23 are open.

When the supply hole 22 is open, new toner is transferred from the new toner containing portion 20 toward the supply hole 22, through a first screw 27 shown in FIG. 3, and then the new toner is supplied to the outside, that is, the electrophotographic apparatus through the supply hole 22 and the opening 50.

Also, when the receiving hole 23 is open, waste toner comes in along the receiving path 25 through the opening 51 and the receiving hole 23, and is transferred toward the waste toner containing portion 21 by the second screw 28 shown in FIG. 3.

The toner cartridge according to a preferred embodiment of the present invention having the above structure operates the shutter 30 to open/shut the supply hole 22 and the receiving hole 21 by being engaged with the installing/detaching action with respect to the loading portion 12. Thus, an additional work to open/shut the supply hole 22 and the receiving hole 23 is not necessary during the exchange of cartridges, so that work productivity can be improved.

Also, since the supply hole 22 and the receiving hole 23 is open and shut by the single shutter 30, the number of parts can be reduced and cost can be reduced compared to the conventional technology.

Also, every constituent elements including the locking arm 42 of the toner cartridge 11 according to the present preferred embodiment is formed of resin. Thus, the toner cartridge 11 that is used up can be easily disposed of.

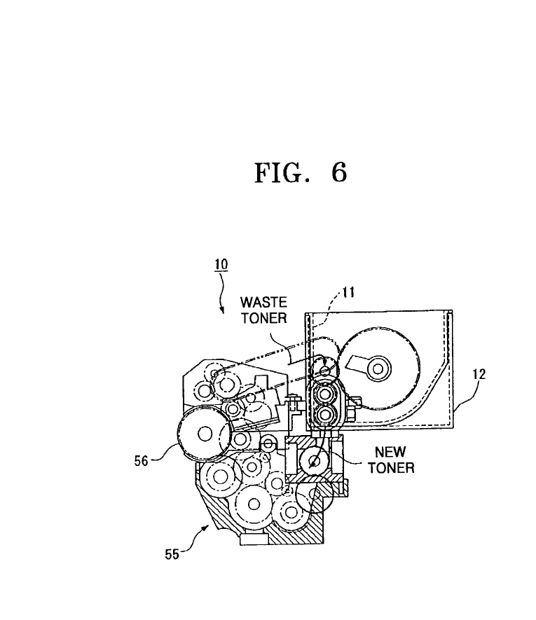

FIG. 6 shows an electrophotographic apparatus according to a preferred embodiment of the present invention. The electrophotographic apparatus 10 according to the present preferred embodiment adopts the toner cartridge 11 with reference to FIGS. 2 through 5.

Referring to FIG. 6, the toner cartridge 11 is detachably loaded in the loading portion 12 installed at the main body of the electrophotographic apparatus. Also, new toner supplied from the toner cartridge 11 adheres to a photoreceptive drum 56 installed at a process unit 55 having a plurality of rollers. Also, a transfer roller, a cleaner for removing remaining toner, a charging roller, and a laser scanning unit for recording an electrostatic latent image on a surface of the photoreceptive drum 56 charged to a predetermined electric potential by the charging roller, which are not shown in the drawing, are installed in the process unit 55. When new toner adheres to the surface of the photoreceptive drum 56 where an electrostatic latent image is formed, print paper passes between the photoreceptive drum 56 and the transfer roller. Accordingly, the toner is transferred to the print paper so that text or images are formed on the print paper. Also, after transfer, unnecessary toner adhering to the surface of the photoreceptive drum 56 is removed by the cleaner and collected in the toner cartridge 11 as waste toner.

As described above, in the toner cartridge according to the present invention and the electrophotographic apparatus adopting the toner cartridge, the new toner supply hole and the waste toner receiving hole are installed at a predetermined portion of the toner cartridge and the new toner supply hole and the waste toner receiving hole are open/shut by the single shutter. Thus, a low manufacturing cost is possible and the toner cartridge can be easily replaced.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A toner cartridge which is detachably loaded in a predetermined loading portion and has a new toner containing space where new toner is contained and a waste toner containing space where waste toner is contained, the toner cartridge comprising:
a supply hole for supplying new toner and a receiving hole for receiving waste toner, which are installed at a predetermined position of a main body of the toner cartridge; and
an open and shut mechanism for opening and shutting the supply hole and the receiving hole by a single shutter.

2. The toner cartridge as claimed in claim 1, further comprising at least one of a first transfer unit for transferring the new toner from the new toner containing space to the supply hole and a second transfer unit for transferring the waste toner from the receiving hole to the waste toner containing space.

3. The toner cartridge as claimed in claim 1, wherein the open and shut mechanism opens and shuts the supply hole and the receiving hole by operating the shutter, in engagement with installation and detaching operations with respect to the loading portion.

4. The toner cartridge as claimed in claim 3, wherein the open and shut mechanism comprises:
a driven portion installed at the shutter; and
a guide groove formed in the loading portion so that the driven portion moves when the toner cartridge is installed at or detached from the loading portion, for guiding the movement of the shutter through the driven portion.

5. The toner cartridge as claimed in claim 3, further comprising at least one of a first transfer unit for transferring the new toner from the new toner containing space to the supply hole and a second transfer unit for transferring the waste toner from the receiving hole to the waste toner containing space.

6. The toner cartridge as claimed in claim 1, wherein every elements including the open and shut mechanism is formed of resin.

7. An electrophotographic apparatus for forming an image on a recording medium by adhering toner to a photoreceptive body where an electrostatic latent image is formed and transferring the toner to the recording medium from the photoreceptive body, the electrophotographic apparatus comprising:
a loading portion where the toner cartridge is detachably installed the toner cartridge,
wherein the toner cartridge comprises:
a new toner containing space where new toner is contained and a waste toner containing space where waste toner is contained;
a supply hole for supplying new toner and a receiving hole for receiving waste toner, which are installed at a predetermined position of a main body of the toner cartridge; and
an open and shut mechanism for opening and shutting the supply hole and the receiving hole by a single shutter.

8. The electrophotographic apparatus as claimed in claim 7, wherein the toner cartridge comprises at least one of a first transfer unit for transferring the new toner from the new toner containing space to the supply hole and a second transfer unit for transferring the waste toner from the receiving hole to the waste toner containing space.

9. The electrophotographic apparatus as claimed in claim 7, wherein the open and shut mechanism opens and shuts the supply hole and the receiving hole by operating the shutter, in engagement with installation and detaching operations with respect to the loading portion, and comprises:
a driven portion installed at the shutter; and
a guide groove formed in the loading portion so that the driven portion moves when the toner cartridge is installed at or detached from the loading portion, for guiding the movement of the shutter through the driven portion.

10. The electrophotographic apparatus as claimed in claim 9, where the toner cartridge further comprises at least one of a first transfer unit for transferring the new toner from the new toner containing space to the supply hole and a second transfer unit for transferring the waste toner from the receiving hole to the waste toner containing space.
